(19) United States
(12) Patent Application Publication
(10) Pub. No.: US 2026/0337399 A1
(43) Pub. Date: Oct. 29, 2026

(54) Acrylonitrile-butadiene-styrene material composition

(71) Applicant: Skytech, Le Val D'Hazey (FR)

(72) Inventors: Michaël LEMOINE, Paris (FR); Thomas BOGAERT, Asnieres Sur Seine (FR); Corentin TOIGO, Vernon (FR)

(21) Appl. No.: 19/103,746

(22) PCT Filed: Aug. 16, 2023
(86) PCT No.: PCT/EP2023/072616

§ 371 Date: Feb. 13, 2025

(30) Foreign Application Priority Data
Aug. 17, 2022 (FR) FR2208338

(51) Int. Cl. C08L 55/02; C08J 3/20; C08K 5/134; C08K 5/524

(52) U.S. Cl. CPC C08L 55/02; C08J 3/203; C08K 5/134; C08K 5/524; C08J 2355/02; C08J 2423/08; C08J 2435/06; C08J 2453/00; C08J 2455/02; C08L 2201/08; C08L 2205/025; C08L 2205/035; C08L 2207/20

(57) ABSTRACT

The present invention relates to a composition comprising:
an acrylonitrile-butadiene-styrene polymer or an acrylonitrile-butadiene-styrene polymer derivative,
a high thermal resistance additive selected from a terpolymer of an N-substituted maleimide monomer, a vinyl monomer and an unsaturated dicarboxylic acid anhydride monomer, and a polyalphamethylstyrene, and mixtures thereof,
at least one impact modifier additive, and
at least one antioxidant additive.

The present invention relates to a composition of acrylonitrile-butadiene-styrene material comprising different additives. The present invention also relates to a method of preparing said composition. The present invention also relates to the use of said composition to manufacture a part. The present invention also relates to a part comprising said composition.

Products in plastic materials are generally formed from virgin plastic materials (also known as primary plastic materials). For example, the material acrylonitrile-butadiene-styrene (abbreviation ABS) is a plastic material used in numerous applications of everyday life: toys, consumer goods, telephones, household appliances, automotive vehicle parts and in particular inner parts. Although this material as such exhibits advantageous properties of impact strength and toughness, it is known to add one or more additives thereto to produce different grades having specific properties. However, there still remains a need to improve and/or modulate the performance thereof according to targeted application.

There is therefore a need for acrylonitrile-butadiene-styrene materials having both good impact strength and good heat resistance.

In addition, current expectations for environmental protection and a reduction in the consumption of resources are increasingly growing stronger, and it is therefore necessary to develop new materials obtained from recycled materials, in particular from recycled ABS.

The disadvantage of the use of recycled ABS is that it generally has degraded performance compared with the corresponding initial virgin ABS, in particular with respect to impact strength and heat resistance. Additionally, the future use of recycled ABS is not necessarily the same as the past use thereof, which implies that the properties of the recycled polymer must be modified/adapted to this new use.

There is a need for recycled acrylonitrile-butadiene-styrene materials exhibiting good performance, in particular thermal and mechanical performance that is same or better than that of virgin acrylonitrile-butadiene-styrene materials.

It is one objective of the invention to provide a composition of acrylonitrile-butadiene-styrene material, in particular recycled acrylonitrile-butadiene-styrene material, having good performance with regard to impact strength and heat resistance.

In particular, one objective of the present invention is to provide a composition of acrylonitrile-butadiene-styrene material, in particular recycled acrylonitrile-butadiene-styrene material, having a flexural modulus higher than or equal to 2150 MPa, preferably higher than or equal to 2300 MPa.

It is another particular objective of the invention to provide a composition of acrylonitrile-butadiene-styrene material, in particular recycled acrylonitrile-butadiene-styrene material, having an IZOD impact strength higher than or equal to 9 kJ/m², preferably higher than or equal to 10 kJ/m².

It is another particular objective of the invention to provide a composition of acrylonitrile-butadiene-styrene material, in particular recycled acrylonitrile-butadiene-styrene material, having a heat deflection temperature higher than or equal to 95 °C, preferably higher than or equal to 99 °C, or Vicat point higher than or equal to 94 °C, preferably higher than to equal to 97 °C.

A further objective of the invention is to provide a composition of acrylonitrile-butadiene-styrene material, in particular recycled acrylonitrile-butadiene-styrene material, not only having a flexural modulus higher than or equal to 2150 MPa, preferably higher than or 2300 MPa, and an IZOD impact strength higher than or equal to 9 kJ/m², preferably higher than or equal to 10 kJ/m², but also a heat deflection temperature higher than or equal to 95 °C, preferably higher than or equal to 99 °C, or a Vicat point higher than or equal to 94 °C, preferably higher than or equal to 97 °C.

The present invention therefore concerns a composition comprising:
an acrylonitrile-butadiene-styrene polymer or an acrylonitrile-butadiene-styrene polymer derivative,
a high heat resistant additive chosen from among a terpolymer of an N-substituted maleimide monomer, a vinyl monomer and an unsaturated dicarboxylic acid anhydride monomer, and a polyalphamethylstyrene, and mixtures thereof;
at least one impact modifying additive; and
at least one antioxidant additive.

Preferably, in the composition of the invention, the weight content of high heat resistance additive varies from 15% to 35%, preferably from 18% to 30%, advantageously from 20 to 25% by weight, relative to the total weight of the composition.

Preferably, in the composition of the invention the total weight content of impact modifying additive varies from 8 to 35 weight %, preferably 10 to 25 weight %, more preferably 12 to 20 weight %, advantageously 13 to 18 weight %, relative to the total weight of the composition.

Preferably, in the composition of the invention, the ratio between the total weight of impact modifying additive and weight content of high heat resistant additive varies from 0.3 to 2.0, preferably from 0.4 to 1.5, more preferably from 0.5 to 1.2, further preferably from 0.6 to 1.0, advantageously from 0.65 to 0.85.

Preferably, in the composition of the invention, the content of acrylonitrile-butadiene-styrene polymer or of acrylonitrile-butadiene-styrene polymer derivative varies from 40% to 75%, preferably from 50% to 70%, more preferably from 55% to 65%, advantageously from 60% to 65% by weight, relative to the total weight of the composition.

Preferably, the composition of the invention is characterized by a flexural modulus at 23 °C having a value higher than or equal to 1800 MPa, preferably higher than or equal to 2000 MPa, more preferably higher than or equal to 2300 MPa, further preferably between 2000 MPa and 2800 MPa, advantageously between 2200 MPa and 2500 MPa, advantageously between 2300 and 2500 MPa.

The value of the flexural modulus of the composition of the invention is determined according to standard ISO 178 (2019 version).

Preferably the composition of the invention is characterized by an IZOD impact strength higher than or equal to 7.5 kJ/m², preferably higher than or equal to 8.0 kJ/m², more preferably higher than or equal to 9.8 kJ/m², more preferably between 8.5 and 16 kJ/m², further preferably between 9.0 and 15 kJ/m², advantageously between 9.8 and 12.5 kJ/m².

The value of the IZOD impact strength of the composition of the invention corresponds to the IZOD impact strength of a notched sample at 23 °C, determined according to standard ISO 180 of 2019.

Preferably, the composition of the invention is characterized by a heat deflection temperature (HDT) higher than or equal to 95 °C, preferably higher than or equal to de 96 °C, more preferably higher than or equal to 97 °C, further preferably higher than or equal to 98 °C, still further preferably higher than or equal to 99 °C. The value of the heat deflection temperature can preferably lie between 95 °C and 103 °C, advantageously between 97 °C and 101 °C.

The value of the heat deflection temperature of the composition of the invention is determined according to standard ISO 75-2A (2013 version).

Preferably, the composition of the invention is characterized by a Vicat softening point having a value higher than or equal to 94 °C, preferably higher than or equal to 97 °C, more preferably higher than or equal to 99 °C, further preferably higher than or equal to 100 °C, still further preferably higher than or equal to 103 °C. The Vicat softening point can preferably lie between 94 °C and 110 °C, advantageously between 101 °C and 105 °C.

The Vocat softening point of the composition of the invention is determined according to standard ISO 306 (2013 version).

### Acrylonitrile-Butadiene-Styrene Polymer (ABS) and Derivatives

The composition of the invention comprises an acrylonitrile-butadiene-styrene polymer or an acrylonitrile-butadiene-styrene polymer derivative.

In the invention, an acrylonitrile-butadiene-styrene polymer derivative is a copolymer wherein an aromatic vinyl monomer and a vinyl cyanide monomer are grafted onto a rubber polymer.

The rubber copolymer is preferably chosen from the group formed by diene-based rubbers such as polybutadiene, polystyrene-butadiene and polyacrylonitrile-butadiene, saturated rubbers obtained by hydrogenation of diene-based rubbers, acrylic rubbers such as C1-C8 alkyl acrylate, polybutyl acrylate and ethylhexyl acrylate, isoprene rubbers, chloroprene rubbers, ethylene-propylene rubbers (EPM) and ethylene-propylene-diene monomers (EPDM). Preferably, the rubber polymer is chosen from among diene-based rubbers, more preferably it is polybutadiene.

The content of rubber polymer preferably ranges from 5 to 30 weight % relative to the total weight of the acrylonitrile-butadiene-styrene polymer derivative.

The aromatic vinyl monomer is preferably chosen form the group formed by styrene, α-methylstyrene, β-methylstyrene, p-methylstyrene, ethylstyrene, hydroxystyrene, vinyl-xylene, monochlorostyrene, dichlorostyrene, dibromostyrene and vinylnaphthalene, and is preferably styrene.

The content of aromatic vinyl compound preferably ranges from 35 to 80 weight % relative to the total weight of the acrylonitrile-butadiene-styrene polymer derivative.

The vinyl cyanide monomer is preferably chosen from among saturated nitriles such as acrylonitrile and unsaturated nitriles such as methacrylonitrile and ethacrylonitrile, and is preferably acrylonitrile.

The content of vinyl cyanide compound preferably ranges from 15 to 35 weight % relative to the total weight of the acrylonitrile-butadiene-styrene polymer derivative.

Preferably the composition of the invention comprises an acrylonitrile-butadiene-styrene polymer.

In the invention, an acrylonitrile-butadiene-styrene polymer is a polymer obtained by grafting, preferably by emulsion grafting of acrylonitrile and styrene on a polybutadiene, by dispersion of an acrylonitrile-butadiene copolymer in a matrix of acrylonitrile-styrene copolymer, or by bulk polymerization of acrylonitrile and styrene in the presence of polybutadiene. Preferably, the acrylonitrile-butadiene-styrene polymer is a resin wherein a styrene-acrylonitrile copolymer is grafted onto a polybutadiene.

It generally comprises from 15 to 35 weight % of acrylonitrile, from 5 to 30 weight % of butadiene and from 35 to 80 weight % of styrene, relative to the total weight of the acrylonitrile-butadiene-styrene polymer.

Preferably, the acrylonitrile-butadiene-styrene polymer has a number average molecular weight of between 50 000 et 75 000 g/mol.

The acrylonitrile-butadiene-styrene polymer has a weight average molecular weight of between 100 000 and 150 000 g/mol.

Preferably, the acrylonitrile-butadiene-styrene polymer has a number average molecular weight Mn of between 50 000 and 75 000 g/mol, and weight average molecular weight of between 100 000 and 150 000 g/mol.

In one particular embodiment, the acrylonitrile-butadiene-styrene polymer or the acrylonitrile-butadiene-styrene polymer derivative is recycled.

By recycled polymer, it is meant a post-consumer polymer i.e. having been used to manufacture a product. In contrast, a virgin (or primary) polymer is a polymer obtained after a polymerization process allowing the preparation thereof from one or more monomers. Post-industrial polymers also exist designating plastic waste generated by manufacturers of the consumer products mentioned above. Finally, post-production polymers are waste generated by manufacturers of plastic materials. The thermomechanical properties of post-production polymers are much closer to those of virgin polymers than those of post-consumer or post-industrial polymers. A post-consumer polymer has undergone impacts and/or variations in temperatures and/or UV radiation, and the thermomechanical properties thereof are lessened compared with those of a virgin polymer or post-production polymer. A post-industrial polymer also has modified properties compared with a virgin polymer insofar as it has undergone processing steps.

A recycled acrylonitrile-butadiene-styrene polymer of the invention is a post-consumer acrylonitrile-butadiene-styrene polymer or a post-industrial acrylonitrile-butadiene-styrene polymer, preferably post-consumer.

Typically, a post-consumer acrylonitrile-butadiene-styrene polymer has a flexural modulus lower than or equal to 2700 MPa, preferably lower than or equal to 2550 MPa, preferably ranging from 2200 MPa to 2700 MPa, more preferably ranging from 2300 to 2550 MPa, and/or has an IZOD impact strength lower than or equal to 12 kJ/m², preferably lower than or equal to 8 kJ/m², preferably ranging from 6 to 12 kJ/m², more preferably ranging from 6.5 to 8 kJ/m², and/or has a heat deflection temperature lower than or equal to 91 °C, preferably between 85 °C and 91 °C.

The recycled acrylonitrile-butadiene-styrene polymer is obtained after collection of consumer products comprising acrylonitrile-butadiene-styrene polymer, grinding these products, separation of the regrind material comprising acrylonitrile-butadiene-styrene polymer, and melting this regrind material.

### Terpolymer of an N-Substituted Maleimide Monomer, a Vinyl Monomer and an Unsaturated Dicarboxylic Acid Anhydride Monomer, a Polyalphamethylstyrene, and Mixtures Thereof.

The composition of the invention may comprise a high heat resistant additive comprising a terpolymer of an N-substituted maleimide monomer, a vinyl monomer and an unsaturated dicarboxylic acid anhydride monomer (called terpolymer P in the remainder hereof).

The N-substituted maleimide monomer is preferably chosen from the group formed by N-alkylmaleimides such as N-methylmaleimide, N-ethylmaleimide, N-butylmaleimide and N-cyclohexylmaleimide, and N-arylmaleimides, such as N-phenylmaleimide, N-methylphenylmaleimide and N-chlorophenylmaleimide. Preferably, the N-substituted maleimide monomer is N-phenylmaleimide.

The content of N-substituted maleimide monomer preferably ranges from 45 to 55 weight % relative to the total weight of the terpolymer P.

The vinyl monomer is preferably chosen from the group formed by styrene, o-methylstyrene, m-methylstyrene, p-methylstyrene, 2,4-dimethylstyrene, ethylstyrene, p-tert-butylstyrene, α-methylstyrene and α-methyl-p-methylstyrene. Preferably, the vinyl monomer is styrene.

The content of vinyl monomer preferably ranges from 40 to 50 weight % relative to the total weight of the terpolymer P.

The unsaturated dicarboxylic acid anhydride monomer is preferably chosen from among maleic anhydride, itaconic anhydride, citraconic anhydride and aconitic anhydride. Preferably, the unsaturated dicarboxylic acid anhydride monomer is maleic anhydride.

The content of unsaturated dicarboxylic acid anhydride monomer preferably ranges from 5 to 10 weight % relative to the total weight of the terpolymer P.

Preferably, the terpolymer P has a weight average molecular weight of between 70 000 g/mol and 300 000 g/mol and/or a glass transition temperature of between 184 °C and 197 °C.

Preferably, the terpolymer P is a styrene-N-phenylmaleimide-maleic anhydride.

The styrene-N-phenylmaleimide-maleic anhydride terpolymer preferably comprises from 45 to 55 weight % of N-phenylmaleimide, from 40 to 50 weight % of styrene and from 5 to 10 weight % of maleic anhydride.

For example, the styrene-N-phenylmaleimide-maleic anhydride terpolymer can be chosen from among styrene-N-phenylmaleimide-maleic anhydride terpolymers commercially available under the reference DENKA® P MS-CP or DENKA® P MS-NJP, by DENKA.

### Polyalphamethylstyrene

The composition of the invention may comprise a high heat resistant additive comprising a poly(alpha-methylstyrene).

For example, the high heat resistant additive comprising polyalphamethylstyrene can be the commercial product available under references ACMA00017077 and ACM9011114 by ALFA Chemistry, or the commercial product available under the reference M-80 by Jiasheng High-Tech Modified Material Co. Ltd.

### Impact Modifier Additive

The composition of the invention comprises at least one impact modifier additive.

By impact modifier additive, it is meant a chemical compound which, when mixed with a polymer, imparts better impact strength to said polymer. An impact modifier additive in particular is a polymer material improving the impact properties of a polymer e.g. the IZOD impact strength at 23 °C on a notched sample as determined according to standard ISO 180 (2019) version. This term is also known under the name “impact strength improver” or “impact additive” or “toughening agent”. This term is well known to persons skilled in the art.

Preferably, in the invention, an impact modifier additive is an additive enabling a polymer comprising 5 weight % of this additive, relative to the total weight of the polymer-additive mixture, to exhibit a rate increase in impact strength higher than or equal to 1.2, preferably higher than or equal to 1.5, more preferably higher than or equal to 2.0.

Therefore, preferably, the impact modifier additive allows an increase of at least 10% in the IZOD impact strength of a composition comprising the recycled polymer and 5% of said impact modifier additive.

Examples of suitable impact modifier additives include for example grafted polymers, core-shell polymers, and block copolymers. These polymers can be obtained from at least one monomer chosen from the group formed by an alkene, alkadiene, arene and acrylate.

Preferably, the impact modifier additive is a copolymer obtained from at least one vinyl monomer.

By copolymer, it is meant a polymer obtained by copolymerization of at least two or more types of monomer that are chemically different and called comonomers.

By vinyl monomer, it is meant an organic molecule comprising at least one carbon-carbon double bond. Preferably, the vinyl monomer has the following formula: CH₂═CRR′, with R and R′ each independently being chosen from the group formed by a hydrogen atom, an aromatic group preferably phenyl, a hydrocarbon group having 1 to 10 carbon atoms preferably 2 to 10 carbon atoms, saturated or unsaturated optionally additionally comprising an ester group, nitrile group, carboxyl group, amine group or amide group.

Preferably, the impact modifier additive is a copolymer of ethylene and/or styrene i.e. at least one of the comonomers of the copolymer is chosen from among styrene and ethylene.

Preferably, the impact modifier additive comprises a copolymer derived from copolymerization of at least two monomers chosen from the group formed by a C2-C8 alkene, C4-C8 diene, a styrene monomer and an acrylic monomer.

More preferably, said impact modifier additive comprises a copolymer obtained from copolymerization of at least two monomers chosen from the group formed by ethylene, butene, styrene, butadiene, acrylonitrile, (m)ethyl (meth)acrylate and butyl (meth)acrylate.

In some embodiments, the impact modifier additive is functionalized or grafted. The functionalized or grafted ethylene copolymer may comprise polar compounds, for example comprising an anhydride or epoxy function, preferably cyclic, more preferably maleic anhydride or glycidyl (meth)acrylate.

Preferably, the impact modifier additive is chosen from among:
copolymers of ethylene and/or butene and a polar monomer chosen from among (m)ethyl acrylate, (m)ethyl methacrylate and butyl (meth)acrylate;
modified acrylonitrile-butadiene-styrene copolymers having a butadiene content higher than or equal to 60 weight % relative to the total weight of the modified acrylonitrile-butadiene-styrene polymer,
styrene-ethylene/butene-styrene copolymers grafted with maleic anhydride or glycidyl methacrylate;
ethylene-butyl acrylate copolymers, optionally grafted with maleic anhydride;
styrene-butadiene copolymers, preferably block styrene-butadiene copolymers, preferably multiblock or diblock styrene-butadiene copolymers;
styrene-ethylene/butene-styrene copolymers, preferably block styrene-ethylene/butene-styrene copolymers;
   and
any of the mixtures thereof.

As an example of styrene-ethylene/butene-styrene copolymer functionalized with maleic anhydride, mention can be made of the product referenced SEBS-g-MA® by Kraton Polymer.

As an example of styrene-ethylene/butene-styrene copolymers grafted with maleic anhydride, mention can be made of the product referenced C1010® by Kraton Polymer.

As an example of styrene-ethylene/butene-styrene copolymers grafted with glycidyl methacrylate, mention can be made of the product referenced 02520 C® by Graft polymer.

As an example of ethylene-butyl acrylate copolymers, mention can be made of the product Lucofin® 1400PN by Lucobit.

As an example of ethylene-butyl acrylate copolymers grafted with maleic hydride, mention can be made of the product Lucofin® 1492 MGH by Lucobit.

As an example of styrene-butadiene copolymer, mention can be made of the product referenced SBS-C3000® by Kraton Polymer or the product referenced DENKA NSBC® by DENKA.

As an example of styrene-ethylene/butene-styrene copolymer, mention can be made of the product referenced SBS-C2000® by Kraton Polymer.

Copolymers of Ethylene and/or Butene and a Polar Monomer Chosen from Among (m)Ethyl Acrylate, (m)Ethyl Methacrylate and Butyl (Meth)Acrylate

(M)ethyl indicates methyl or ethyl group.

(Meth)acrylate indicates acrylate or methacrylate.

Preferably, the copolymer of ethylene and/or butene and a polar monomer chosen from among (m)ethyl acrylate, (m)ethyl methacrylate and butyl (meth)acrylate is a copolymer of ethylene and a polar monomer chosen from among (m)ethyl acrylate and (m)ethyl methacrylate.

Preferably, the copolymer of ethylene and/or butene and a polar monomer chosen from among (m)ethyl acrylate, (m)ethyl methacrylate and butyl (meth)acrylate is a random copolymer. Said copolymer can be prepared at high pressure from a mixture of ethylene and/or butene and a polar monomer chosen from among (m)ethyl acrylate, (m)ethyl methacrylate and butyl (meth)acrylate in the presence of a radical polymerization initiator.

The copolymer of ethylene and a polar monomer chosen from among (m)ethyl acrylate and (m)ethyl methacrylate preferably comprises from 5 to 30 weight %, preferably 10 to 30 weight %, more preferably 15 to 31 weight % of polar monomer relative to the total weight of the copolymer, and from 70 to 95 weight % of ethylene, preferably 70 to 90 weight %, more preferably 69 to 85 weight % relative to the total weight of the copolymer.

Preferably, the copolymer of ethylene and/or butene and a polar monomer chosen from among (m)ethyl acrylate, (m)ethyl methacrylate and butyl (meth)acrylate is a copolymer of ethylene and methyl acrylate.

As an example of copolymer of ethylene and/or butene and a polar monomer chosen from among (m)ethyl acrylate, (m)ethyl methacrylate and butyl (meth)acrylate, mention can be made of commercially available ethylene/methyl acrylate copolymers under the reference Lotryl®29MA03T by SK Functional Polymer, Elvaloy® copolymers (AC1125, AC12024 S, AC1330) by Dow, or the products EMAC® SP2260, EMAC® SP2403, EMAC® SP2268 by Westlake.

Modified Acrylonitrile-Butadiene-Styrene Polymer Having a Butadiene Content Higher than or Equal to 60 Weight %

Preferably, the modified acrylonitrile butadiene styrene polymer having a butadiene content higher than 60 weight % comprises a modified acrylonitrile butadiene styrene polymer having a butadiene content ranging from 60% to 80%, more preferably ranging from 60% to 65% by weight relative to the total weight of the modified acrylonitrile butadiene polymer.

This polymer therefore differs in particular from the above-described acrylonitrile-butadiene-styrene polymer in that it has a higher content of butadiene (higher than or equal to 60 weight %).

As an example of modified acrylonitrile butadiene styrene polymer having a butadiene content higher than or equal to 60 weight %, mention can be made of the product referenced KUMHO® HR 181 by Korea Kumho Petrochemical.

Preferably, the impact modifier additive is chosen from among:
copolymers of ethylene and/or butene and a polar monomer chosen from among (m)ethyl acrylate, (m)ethyl methacrylate and butyl (meth)acrylate;
modified acrylonitrile-butadiene-styrene copolymers having a butadiene content higher than or equal to 60 weight % relative to the total weight of the modified acrylonitrile-butadiene-styrene polymer;
styrene-butadiene copolymers, preferably block styrene-butadiene copolymers, preferably multiblock or diblock styrene-butadiene copolymers; and
any of the mixtures thereof,
   in any combination of variants defined above for each of these copolymers.

In one embodiment, the impact modifier additive comprises at least one first impact modifier additive and one second impact modifier additive.

The first impact modifier additive and the second impact modifier additive differ from each other and are preferably each independently an impact modifier additive according to any above-defined variant.

Preferably, the first impact modifier additive and the second impact modifier additive differ from each other and are each independently chosen from among:
copolymers of ethylene and/or butene and a polar monomer chosen from among (m)ethyl acrylate, (m)ethyl methacrylate and butyl (meth)acrylate;
modified acrylonitrile-butadiene-styrene copolymers having a butadiene content higher than or equal to 60 weight %, relative to the total weight of the modified acrylonitrile-butadiene-styrene polymer;
styrene-butadiene copolymers, and
any of the mixtures thereof.
   All the above-defined variants apply to each of these copolymers

Preferably, the ratio between the total weight content of first and second impact modifier additives and the weight content of high heat resistant additive varies from 0.3 to 2.0, preferably from 0.4 to 1.5, more preferably from 0.5 to 1.2, further preferably from 0.6 to 1.0, advantageously from 0.65 to 0.85.

Preferably, the ratio between the weight content of second impact modifier additive and weight content of first impact modifier additive varies from 0.1 to 12, preferably varies from 0.3 to 8.0, more preferably from 0.4 to 6.0, further preferably from 0.5 to 3.0.

Preferably, the weight content of first impact modifier additive varies from 2% to 18%, preferably from 3% to 15%, more preferably from 4% to 12%, advantageously from 4% to 8% by weight, relative to the total weight of the composition.

Preferably, the weight content of second impact modifier additive varies from 5% to 25%, preferably from 6% to 20%, more preferably from 7% to 16%, advantageously from 8% to 12% by weight, relative to the total weight of the composition.

More preferably, the first impact modifier additive is chosen from among copolymers of ethylene and/or butene and a polar monomer chosen from among (m)ethyl acrylate, (m)ethyl methacrylate and butyl (meth)acrylate, and the second impact modifier additive is chosen from among modified acrylonitrile-butadiene-styrene copolymers having a butadiene content higher than or equal to 60% by weight, relative to the total weight of the modified acrylonitrile-butadiene-styrene polymer, or

the first impact modifier additive is chosen from among styrene-butadiene copolymers, and the second impact modifier additive is chosen from among copolymers of ethylene and/or butadiene and a polar monomer chosen from among (m)ethyl acrylate, (m)ethyl methacrylate and butyl (meth)acrylate, and modified acrylonitrile-butadiene-styrene copolymers having a butadiene content higher than or equal to 60% by weight relative to the total weight of the modified acrylonitrile-butadiene-styrene polymer.

Advantageously, the first impact modifier additive is a copolymer of ethylene and (m)ethyl (meth)acrylate, preferably a copolymer of ethylene and methyl acrylate, and the second impact modifier additive is chosen from among modified acrylonitrile-butadiene-styrene copolymers having a butadiene content higher than or equal to 60% by weight relative to the total weight of the modified acrylonitrile-butadiene-styrene polymer.

All the above-defined variants for each of these copolymers and all the variants concerning the contents of first and second impact modifier additive are applicable.

### Antioxidant Additives

The composition of the invention comprises at least one antioxidant additive.

Preferably, the antioxidant additives are chosen from the group formed by:
hindered phenol compounds such as triethylene glycol bis[3-(3-t-butyl-5-methyl-4-hydroxyphenyl)propionate], 1,6-hexanediol bis[3-(3,5-di-t-butyl-4-hydroxyphenyl)propionate], 2,4-bis(n-octylthio)-6-(4-hydroxy-3,5-di-t-butylanilino)-1,3,5-triazine, pentaerythrityl tetrakis[3-(3,5-di-t-butyl-4-hydroxyphenyl)propionate], 2,2-thiodiethylene bis[3-(3,5-di-t-butyl-4-hydroxyphenyl)propionate], octadecyl 3-(3,5-di-t-butyl-4-hydroxyphenyl)propionate, N,N′-hexamethylene bis(3,5-di-t-butyl-4-hydroxy-hydrocinnamamide), tetrakis(methylene (3,5-di-tert-butyl-hydroxy-hydrocinnamate)) methane, and octadecyl 3,5-di-tert-butylhydroxyhydrocinnamate, preferably it is N,N′-hexamethylene bis(3,5-di-t-butyl-4-hydroxy-hydrocinnamamide),
organic phosphites such as tetrakis(2,4-di-tert-butylphenyl) [1,1-biphenyl]-4,4′-diylbisphosphonite, tris(2,4-di-tert-butylphenyl) phosphite, bis(2,4-di-tert-butylphenyl) pentaerythritol diphosphite, bis(2,4-dicumylphenyl)pentaerythritol diphosphite, tris(nonyl phenyl)phosphite and distearyl pentaerythritol diphosphite, preferably it is tris(2,4-di-tert-butylphenyl) phosphite.

As examples of antioxidant additives, mention can be made of the products referenced IRGANOX 1076, IRGANOX 245 and IRGAFOS 168 FF by BASF.

Preferably, the weight content of antioxidant varies from 0.05% to 1%, preferably from 0.1% to 0.5%, advantageously from 0.15% to 0.25 weight % relative to the total weight of the composition. The composition of the invention may comprise one antioxidant or a mixture of at least two antioxidants. When the composition comprises at least two antioxidants, the antioxidant content indicated above is the total content of anti-oxidants.

Preferably, when the composition comprises at least two antioxidants, it comprises at least one phenol compound and an organic phosphite compound as listed above. Preferably, the weight ratio between the phenol compound(s) and organic phosphite compound(s) ranges from 1:1 to 1:4.

Advantageously, the antioxidant additive of the composition of the invention comprises a mixture of N,N′-hexamethylene bis(3,5-di-t-butyl-4-hydroxy-hydrocinnamamide) and tris(2,4-di-tert-butylphenyl) phosphite.

The present invention also concerns a method for preparing a composition of the invention, comprising:
a step to mix an acrylonitrile-butadiene-styrene polymer or an acrylonitrile-butadiene-styrene polymer derivative, a high heat resistant additive chosen from among a terpolymer of an N-substituted maleimide monomer, a vinyl monomer and unsaturated dicarboxylic acid anhydride monomer, and a polyalphamethylstyrene and mixtures thereof, at least one impact modifier additive and at least one antioxidant additive.

All the definitions and preferred embodiments given in the above description are applicable.

The mixing step is preferably performed at a temperature of between 235 and 290 °C. The mixing step must be performed in an extruder equipped with co-rotating twin screws.

When injecting moulded parts, the temperature of the screw-barrel assembly of the injection press must lie between 220 °C and 250 °C at the time of injection. The recommended mould temperature for injection is between 40 and 70 °C.

The present invention also concerns the use of a composition of the invention to manufacture a part, e.g. a vehicle part, preferably an automotive vehicle part.

The present invention also concerns a method for manufacturing a part preferably a vehicle part, preferably an automotive vehicle part, comprising the moulding of a composition of the invention.

The present invention also concerns a part, preferably a vehicle part, preferably an automotive vehicle part comprising a composition of the invention.

For example, the vehicle part is a vehicle rear light, a part under the bonnet, an inner part of the vehicle, a passenger compartment part.

The composition may also have been previously used to manufacture parts for the electrical and electronic sectors e.g. telephony housings.

The present invention also concerns a method for improving at least one thermal or mechanical property of a recycled acrylonitrile-butadiene-styrene polymer, or recycled acrylonitrile-butadiene-styrene polymer derivative, comprising the addition to the recycled acrylonitrile-butadiene-styrene polymer, or recycled acrylonitrile-butadiene-styrene polymer derivative, of a composition comprising:
a high heat resistant additive chosen from among a terpolymer of an N-substituted maleimide monomer, a vinyl monomer and unsaturated dicarboxylic acid anhydride monomer, and a polyalphamethylstyrene, and mixtures thereof.
at least one impact modifier additive; and
at least one antioxidant additive.

All the definitions and preferred embodiments given in the description are applicable.

Preferably, the method for improving at least one thermal or mechanical property of a recycled acrylonitrile-butadiene-styrene polymer, or a recycled acrylonitrile-butadiene-styrene polymer derivative, is a method for improving the flexural modulus at 23 °C and/or IZOD impact strength and/or heat deflection temperature and/or Vicat softening point of the recycled acrylonitrile-butadiene-styrene polymer or of the recycled acrylonitrile-butadiene-styrene polymer derivative, preferably up to values such as defined in the present description.

The present invention also concerns the use of a combination of:
a high heat resistant additive chosen from among a terpolymer of an N-substituted maleimide monomer, a vinyl monomer and unsaturated dicarboxylic acid anhydride monomer, and a polyalphamethylstyrene, and mixtures thereof,
at least one impact modifier additive; and
at least one antioxidant additive,
   to improve at least one thermal or mechanical property of a recycled acrylonitrile-butadiene-styrene polymer, or of a recycled acrylonitrile-butadiene-styrene polymer derivative.

All the definitions and preferred embodiments given in the above description are applicable.

Preferably, the use of the combination of additives to improve at least one thermal or mechanical property of a recycled acrylonitrile-butadiene-styrene polymer, or of a recycled acrylonitrile-butadiene-styrene polymer derivative, improves the flexural modulus at 23 °C and/or IZOD impact strength and/or heat deflection temperature and/or Vicat softening point of the recycled acrylonitrile-butadiene-styrene polymer, or of the recycled acrylonitrile-butadiene-styrene polymer derivative, preferably up to values such as defined in the present description.

The invention is now described with the following nonlimiting examples.

### EXAMPLES

In all the following examples, the compositions were prepared as follows:

The recycled regrind ABS material (also called post-consumer ABS) was first mechanically mixed with the high heat resistant additive. At the compounding phase, the impact modifier additive(s) and antioxidants were added by means of feed metering hoppers.

In all the following examples, the different thermomechanical properties of the compositions were determined according to the following standards:
IZOD: ISO 180 (2019 version);
Flexural modulus: ISO 178 (2019 version);
VICAT: ISO 306 (2013 version) performed under the conditions of B50 50N;
HDT: ISO 75-2A (2013 version) performed under the following conditions: the test pieces were annealed at 80 °C for 4 h. The weight used for HDT measurement was 1.8 MPa.

### Example 1: Influence of the Quantity and Characteristics of the Heat Resistant Additive

At a first stage, several compositions solely comprising a heat resistant additive, in different contents, were prepared. These compositions do not therefore conform to the invention, but determination of the IZOD strength and HDT of these compositions allowed determination of a range of contents of heat resistant additive to be applied for the imparting of good heat resistance to the compositions, without significant degradation of their mechanical properties

### Case No. 1: Use of DENKA IP MS-NJP

In the compositions in Table 1 below, the following materials and additives were used:
ABS: recycled ABS, EGR0064
Heat resistant additive 1: DENKA IP MS-NJP®
Antioxidant: 0.2% (equal weight mixture of Irganox 1076® and Irganox 168®)
Extrusion temperature: 270 °C
Injection temperature: 250 °C

TABLE 1

| | Heat | Impact | Impact | IZOD | Flexural | | |
|---|---|---|---|---|---|---|---|
| | resistant | modifier | modifier | notched | modulus | | |
| | additive 1 | additive 1 | additive 2 | 23° C. | 23° C. | VICAT | HDT |
| Ref | (wt. %) | (wt. %) | (wt. %) | (kJ/m²) | (MPa) | (° C.) | (° C.) |
| C1-0* | — | — | — | 7.9 | 2520 | 92.5 | 91 |
| C1-1* | 20 | — | — | 4.1 | 2880 ± 30 | 102 | 99 |
| C1-2* | 25 | — | — | 3.7 | 2935 ± 25 | 109 | 103 |
| C1-3* | 35 | — | — | 3.2 | 3100 ± 37 | 115 | 111 |

A content of heat resistant additive of between 20% and 25 weight % allows the obtaining of a good compromise in respect of the mechanical and thermal properties of the composition.

### Case No. 2: Use of DENKA IP MS-CP

In the compositions in Table 2 below, the following materials and additives were used:
ABS: recycled ABS, EGR0064
Heat resistant additive 2: DENKA IP MS-CP®
Antioxidant: 0.2% (equal weight mixture of Irganox 1076® and Irganox 168®)
Extrusion temperature: 235 °C
Injection temperature: 220 °C

TABLE 2

| | Heat | Impact | Impact | IZOD | Flexural | | |
|---|---|---|---|---|---|---|---|
| | resistant | modifier | modifier | notched | modulus | | |
| | additive 1 | additive 1 | additive 2 | 23° C. | 23° C. | VICAT | HDT |
| Ref | (wt. %) | (wt. %) | (wt. %) | (kJ/m²) | (MPa) | (° C.) | (° C.) |
| C1-4* | — | — | — | 7.9 | 2520 | 92.5 | 91 |
| C1-5* | 5 | — | — | 6.7 ± 0.3 | 2500 ± 60 | - | 94.5 ± 0.5 |
| C1-6* | 10 | — | — | 5.6 ± 0.2 | 2650 ± 22 | - | 96.6 ± 0.2 |
| C1-7* | 15 | — | — | 5.4 ± 0.1 | 2660 ± 13 | - | 98.8 ± 0.3 |
| C1-8* | 20 | — | — | 5 ± 0.1 | 2800 ± 38 | - | 100.7 ± 0.6 |

Use of the heat resistant additive IP MS-CP allows an increase in impact strength compared with IP MS-NJP with a lower flexural modulus. The HDT value is higher with this reference: at 20%, 100.7 °C+/−0.6 with IP MS-CP, compared with 99 °C for IP MS-NJP.

### Example 2: Compositions of the Invention Comprising a Heat Resistant Additive and an Impact Modifier Additive

In the compositions in Table 3 below, the following materials and additives were used:
ABS: recycled ABS, EGR0064
Heat resistant additive 1: DENKA IP MS-NJP®
Heat resistant additive 2: DENKA IP MS-CP®
Impact modifier additive 1: Lotryl 29MA03T®
Impact modifier additive 2: HR-181®
Impact modifier additive 3: C3000®
Antioxidant: 0.2% (equal weight mixture of Irganox 1076® and Irganox 168®)
Extrusion temperature: 270 °C
Injection temperature: 250 °C

TABLE 3

| . | Heat | Impact | Impact | Impact | IZOD | Flexural | | |
|---|---|---|---|---|---|---|---|---|
| | resistant | modifier | modifier | modifier | notched | modulus | | |
| | additive 1 | additive 1 | additive 2 | additive 3 | 23° C. | 23° C. | VICAT | HDT |
| Ref | (wt. %) | (wt. %) | (wt. %) | (wt. %) | (kJ/m²) | (MPa) | (° C.) | (° C.) |
| C2-0* | 0 | 0 | 0 | — | 7.9 | — | — | 91 |
| C2-1 | Heat | 8 | — | — | 9.1 ± 0.2 | 2590 ± 20 | 105 | 95.9 ± 0.1 |
| | resistant | | | | | | | |
| | additive 1 | | | | | | | |
| | (15%) | | | | | | | |
| C2-2 | Heat | 10 | — | — | 9.3 ± 0.2 | 2540 ± 30 | 104 | 95.7 ± 0.2 |
| | resistant | | | | | | | |
| | additive 1 | | | | | | | |
| | (15%) | | | | | | | |
| C2-3 | Heat | 12 | — | — | 10.4 ± 0.2 | 2370 ± 30 | 102 | 95.3 ± 0.2 |
| | resistant | | | | | | | |
| | additive 1 | | | | | | | |
| | (15%) | | | | | | | |
| C2-4 | Heat | 24 | — | — | 7 | 1970 ± 19 | 69.1 ± 1.3 | 101.3 ± 0.6 |
| | resistant | | | | | | | |
| | additive 1 | | | | | | | |
| | (25%) | | | | | | | |
| C2-5 | Heat | — | 24 | — | 9.7 | 2200 ± 15 | 105.3 ± 0.6 | 98.7 ± 0.2 |
| | resistant | | | | | | | |
| | additive 1 | | | | | | | |
| | (25%) | | | | | | | |
| C2-6 | Heat | — | — | 15 | 4.8 ± 0.7 | 2110 ± 10 | — | 99.8 ± 0.3 |
| | resistant | | | | | | | |
| | additive 2 | | | | | | | |
| | (20%) | | | | | | | |

### Example 3: Compositions of the Invention Comprising a Heat Resistant Additive and Two Impact Modifier Additives

In the compositions in Table 4 below, the following materials and additives were used:
ABS: recycled ABS, EGR0064
Heat resistance additive 1: DENKA IP MS-NJP®
Impact modifier additive 1: Lotryl 29MA03T®
Impact modifier additive 2: HR-1810
Antioxidant: 0.2% (Equal weight mixture of of Irganox 1076® and Irganox 168®)
Extrusion temperature: 270 °C
Injection temperature: 250 °C

TABLE 4

| | | | | Impact | | | | |
|---|---|---|---|---|---|---|---|---|
| | | | | modifier | | | | |
| | Heat | Impact | Impact | additive 2/ | IZOD | Flexural | | |
| | resistant | modifier | modifier | Impact | notched | modulus | | |
| | additive 1 | additive 1 | additive 2 | modifier | 23° C. | 23° C. | VICAT | HDT |
| Ref | (wt. %) | (wt. %) | (wt. %) | additive 1 | (kJ/m²) | (MPa) | (° C.) | (° C.) |
| C3-1 | 25 | 24 | — | 0 | 7 | 1970 ± 19 | 69.1 ± 1.3 | 101.3 ± 0.6 |
| C3-2 | 25 | 16 | 8 | 0.5 | 7.7 | 2180 ± 32 | 94.4 ± 0.6 | 104 ± 0.6 |
| C3-3 | 25 | 12 | 12 | 1 | 8.2 | 2280 ± 20 | 100.2 ± 0.7 | 102 ± 1 |
| C3-4 | 25 | 8 | 16 | 2 | 11.3 | 2060 ± 10 | 103 | 99 |
| C3-5 | 25 | — | 24 | — | 9.7 | 2200 ± 15 | 105.3 ± 0.6 | 98.7 ± 0.2 |
| C3-6 | 15 | 7.5 | 7.5 | 1 | 15.4 ± 0.2 | 2180 ± 20 | — | 96.5 ± 0.2 |
| C3-7 | 20 | 5 | 10 | 2 | 10.5 | 2330 ± 20 | — | 99.1 ± 0.2 |
| C3-8 | 20 | 7.5 | 7.5 | 1 | 10.3 | 2330 ± 20 | — | 99.1 ± 0.2 |
| C3-9 | 25 | 5 | 15 | 3 | 12.1 ± 0.2 | 2190 ± 20 | — | 99.7 ± 0.1 |
| C3-10 | 25 | 8 | 16 | 2 | 11.3 | 2060 | — | 98.9 ± 0.9 |
| C3-11 | 25 | 7 | 15 | 2.1 | 10.6 | 2100 | — | 99.2 ± 0.3 |

At a total equivalent quantity of impact modifier additive, compositions C3-2, C3-3 and C3-4 exhibit still better mechanical strength than composition C3-1, which only contains a single impact modifier additive. In addition, at a total equivalent quantity of impact modifier additive, compositions C3-2, C3-3 and C3-4 exhibit a still higher heat deflection temperature than composition C3-5 which only contains a single impact modifier additive.

When the ratio of impact modifier additive 2/impact modifier additive 1 is higher than or equal to 2, a synergic effect is observed between the two impact modifier additives. For example, the impact strength of composition C3-4 of the invention is better than that of compositions C3-1 and C3-5 which only contain a single impact modifier additive.

In the compositions in Table 5 below, the following materials and additives were used:
ABS: recycled ABS, EGR0064
Heat resistant additive 2: DENKA IP MS-CP®
Impact modifier additive 1: Lotryl 29MA03T®
Impact modifier additive 2: HR-181®
Antioxidant: 0.2% (equal weight mixture of Irganox 1076® and Irganox 168®)
Extrusion temperature: 235 °C
Injection temperature: 220 °C

TABLE 5

| | | | | Impact | | | |
|---|---|---|---|---|---|---|---|
| | | | | modifier | | | |
| | Heat | Impact | Impact | additive 2/ | IZOD | Flexural | |
| | resistant | modifier | modifier | Impact | notched | modulus | |
| | additive 2 | additive 1 | additive 2 | modifier | 23° C. | 23° C. | HDT |
| Ref | (wt. %)) | (wt. %) | (wt. %) | additive 1 | (kJ/m²) | (MPa) | (° C.) |
| C3-12 | 15 | 15 | — | 0 | 12.5 ± 0.2 | 2160 ± 9 | 93.6 ± 0.6 |
| C3-13 | 15 | 11.25 | 3.75 | 0.33 | 14.4 ± 0.4 | 2120 ± 32 | 97.2 ± 0.3 |
| C3-14 | 15 | 10 | 5 | 0.5 | 14.8 ± 0.3 | 2120 ± 10 | 97.5 ± 0.3 |
| C3-15 | 15 | 7.5 | 7.5 | 1 | 14.7 ± 0.3 | 2140 ± 22 | 97.4 ± 0.6 |
| C3-16 | 15 | 5 | 10 | 2 | 13.9 ± 0.3 | 2260 ± 14 | 95.8 ± 0.4 |
| C3-17 | 15 | 3.75 | 11.25 | 3 | 14.6 ± 0.1 | 2200 ± 19 | 95 ± 0.5 |
| C3-18 | 15 | — | 15 | — | 11.6 ± 0.2 | 2310 ± 7 | 94.3 ± 0.3 |

Irrespective of the ratio of impact modifier additive 2 impact modifier additive 1, a synergic effect is observed between the two impact modifier additives in terms of impact strength and heat resistance.

In the compositions in Table 6 below, the following materials and additives were used:
ABS: recycled ABS, EGR0064
Heat resistant additive 2: DENKA IP MS-OP®
Impact modifier additive 1: Lotryl 29MA03T®
Impact modifier additive 2: HR-181®
Impact modifier additive 3: C3000a
Antioxidant: 0.2% (equal weight mixture of Irganox 1076® and Irganox 168®)
Extrusion temperature: 235 °C
Injection temperature: 220 °C

TABLE 6

| | | | | | Ratio second | | | |
|---|---|---|---|---|---|---|---|---|
| | Heat | Impact | Impact | Impact | impact modifier | IZOD | Flexural | |
| | resistant | modifier | modifier | modifier | additive/first | notched | modulus | |
| | additive 2 | additive 1 | additive 2 | additive 3 | impact modifier | 23° C. | 23° C. | HDT |
| Ref | (wt. %) | (wt. %) | (wt. %) | (wt. %) | additive | (kJ/m²) | (MPa) | (° C.) |
| C3-19 | 20 | — | — | 15 | — | 4.8 ± 0.7 | 2110 ± 10 | 99.8 ± 0.3 |
| C3-20 | 20 | 10 | — | 5 | 2 | 10.3 ± 0.5 | 2120 ± 27 | 99 ± 0.4 |
| C3-21 | 18 | — | 10 | 5 | 2 | 10.3 ± 0.3 | 2310 ± 12 | 98.1 ± 0.3 |
| C3-22 | 20 | — | 10 | 5 | 2 | 10 ± 0.4 | 2230 ± 9 | 98.9 ± 0.4 |
| C3-23 | 20 | — | 13.3 | 6.7 | 2 | 11 ± 0.4 | 2060 ± 2 | 98.4 ± 0.2 |

The additive HR-181® imparts a higher flexural modulus to the formulation of about 200 MPa than Lotry129MA03T® and generates a reduction in the HDT value of 1 °C.

Increasing the amount of impact modifier allows an increase in impact strength, but causes a reduction in HDT.

### Example 4: Influence of the Ratio Between the Total Quantity of Impact Modifier Additives and Quantity of Heat Resistant Additive

In the compositions in Table 7 below, the following materials and additives were used:
ABS: recycled ABS, EGR0064
Hea resistant additive 1: DENKA IP MS-NJP®
Impact modifier additive 1: Lotryl 29MA03T®
Impact modifier additive 2: HR-181®
Antioxidant: 0.2% (equal weight mixture of Irganox 1076® and Irganox 168®)
Ratio: Impact modifier additive 2/Impact modifier additive 1=2
Extrusion temperature: 270 °C
Injection temperature: 250 °C

TABLE 7

| | | | | Weight ratio: | | | | |
|---|---|---|---|---|---|---|---|---|
| | Heat | Impact | Impact | (Impact | | | | |
| | resistant | modifier | modifier | modifiers)/ | | Flexural | | |
| | additive | additive 1 | additive 2 | (heat resistant | IZOD | modulus | VICAT | HDT |
| Ref | 1 (wt. %) | (wt. %) | (wt. %) | additive 1) | (kJ/m²) | (MPa) | (° C.) | (° C.) |
| C4-1 | 22 | 5.5 | 11 | 0.75 | 10.1 ± 0.18 | 2310 ± 21 | - | 99 ± 0.5 |
| C4-2 | 20 | 5 | 10 | 0.75 | 10.3 | 2330 | | 99.1 |
| C4-3 | 25 | 7.33 | 14.67 | 0.88 | 10.6 | 2100 | - | 99.2 ± 0.3 |
| C4-4 | 25 | 8 | 16 | 0.96 | 11.3 | 2060 ± 10 | - | |
| C4-5 | 20 | 6.67 | 13.33 | 1 | 10.8 | 2150 | 99.6 ± 0.2 | 97.2 ± 0.2 |
| C4-6 | 20 | 10 | 20 | 1.5 | 15.6 | 1830 | - | 96.4 |

In the compositions in Table 8 below, the following materials and additives were used:
ABS: recycled ABS, EGR0064
Heat resistant additive 2: DENKA IP MS-CP®
Antioxidant: 0.2% (equal weight mixture of Irganox 1076® and Irganox 168®)
Extrusion temperature: 235 °C
Injection temperature: 220 °C
Ratio: Impact modifier additive 2/Impact modifier additive 1=2

TABLE 8

| | Heat | Impact | Impact | Weight ratio: | IZOD | Flexural | |
|---|---|---|---|---|---|---|---|
| | resistant | modifier | modifier | (Impact modifiers)/ | notched | modulus | |
| | additive 2 | additive 1 | additive 2 | (heat resistant | 23° C. | 23° C. | HDT |
| Ref | (wt. %) | (wt. %) | (wt. %) | additive 2) | (kJ/m²) | (MPa) | (° C.) |
| C4-7 | 21 | 5 | 10 | 0.71 | 12 ± 0.4 | 2330 ± 20 | 99.6 ± 0.4 |
| C4-8 | 17.5 | | | 0.86 | 12.7 ± 0.3 | 2320 ± 38 | 96.6 ± 0.2 |
| C4-9 | 15 | | | 1 | 13.9 ± 0.3 | 2260 ± 14 | 95.8 ± 0.4 |
| C4-10 | 12.5 | | | 1.2 | 15.8 ± 0.4 | 2190 ± 14 | 95.2 ± 0.2 |
| C4-11 | 10 | | | 1.5 | 17 ± 0.3 | 2170 ± 12 | 91.6 ± 0.2 |

In the compositions in Table 9 below, the following materials and additives were used:
ABS: recycled ABS, EGR0064
Heat resistant additive 2: DENKA IP MS-CP®
Impact modifier additive 1: Lotryl 29MA03T®
Impact 2 modifier additive: HR-181®
Antioxidant: 0.2% (equal weight mixture of Irganox 1076® and Irganox 168®)
Extrusion temperature: 235 °C
Injection temperature: 220 °C
Ratio: Impact modifier additive 2/Impact modifier additive 1=1

TABLE 9

| | Heat | Impact | Impact | Weight ratio: | | | |
|---|---|---|---|---|---|---|---|
| | resistant | modifier | modifier | (Impact modifiers)/ | | Flexural | |
| | additive 2 | additive 1 | additive 2 | (heat resistant | IZOD | modulus | HDT |
| Ref | (wt. %) | (wt. %) | (wt. %) | additive 2) | (kJ/m²) | (MPa) | (° C.) |
| C4-12 | 15 | 6 | 6 | 0.8 | 12.1 ± 0.3 | 2320 ± 28 | 98.9 ± 0.3 |
| C4-13 | 15 | 7 | 7 | 0.93 | 13.7 ± 0.3 | 2260 ± 25 | 98.3 ± 0.1 |
| C4-14 | 15 | 7.5 | 7.5 | 1 | 14.7 ± 0.3 | 2140 ± 22 | 97.4 ± 0.6 |
| C4-15 | 15 | 8 | 8 | 1.07 | 14.2 ± 0.3 | 2240 ± 14 | 96.9 ± 0.4 |

The ratio (impact modifiers)/(heat resistant additive) has an influence on the compromise between the mechanical strength and impact strength of the compositions of the invention. The chosen value thereof is dependent on the desired characteristics of the composition.

### Example 5: Other Compositions of the Invention

In the compositions of this example, the following materials and additives were used:
ABS: recycled ABS, EGR0074
Impact modifier additive 1: Lotryl 29MA03T®
Impact modifier additive 2: HR-181®
Antioxidant: 0.2% equal weight mixture of Irganox 1076® and Irganox 168®)
Ratio: Impact modifier additive 2/Impact modifier additive 1=2
Extrusion temperature: 270 °C
Injection temperature: 250 °C

TABLE 10

| | | | | | Wt. ratio: | | | | |
|---|---|---|---|---|---|---|---|---|---|
| | | | | | (Impact | | | | |
| | | Heat | Impact | Impact | modifiers)/ | | | | |
| | Heat | resistant | modifier | modifier | (heat | | Flexural | | |
| | resistant | additive | additive 1 | additive 2 | resistant | IZOD | modulus | VICAT | HDT |
| Ref | additive | (wt. %) | (wt. %) | (wt. %) | additive 2) | (kJ/m²) | (MPa) | (° C.) | (° C.) |
| C5-1* | — | — | — | — | — | 12 | 2480 | 94.3 | 92.5 |
| C5-2 | DENKA IP | 20 | 5 | 10 | 0.75 | 10.4 ± 0.2 | 2330 ± 20 | — | 95.3 ± 0.4 |
| | MS-NJP ® | | | | | | | | |
| C5-3 | DENKA IP | 20 | 5 | 10 | 0.75 | 11.5 ± 0.1 | 2280 ± 30 | — | 98.5 ± 0.5 |
| | MS-CP ® | | | | | | | | |
| C5-4 | DENKA IP | 20 | 4.33 | 8.67 | 0.65 | 10.9 ± 0.6 | 2380 ± 50 | — | 97.1 ± 1.6 |
| | MS-CP ® | | | | | | | | |
| C5-5 | DENKA IP | 22 | 5 | 10 | 0.75 | 10.3 ± 0.3 | 2340 ± 24 | — | 97.3 ± 0.9 |
| | MS-CP ® | | | | | | | | |

These results show that different types of N-phenylmaleimide/styrene/maleic anhydride terpolymers allow compositions of the invention to be obtained having very good thermomechanical properties.

### Example 6: Influence of the Source of Recycled ABS

In the compositions in this example, the following materials and additives were used:
ABS: recycled ABS, EGR0064, EGR0074, PLS0153 BB36, PLS0163 BB1, PLS0160 BB21, EV4003BB1
Heat resistant additive 2: DENKA IP MS-CP®
Impact modifier additive 1: Lotryl 29MA03T®
Impact modifier additive 2: HR-181®
Antioxidant: 0.2% (equal weight mixture of Irganox 1076® and Irganox 168®)
Extrusion temperature: 235 °C
Injection temperature: 220 °C

In the compositions of this example, the proportions of each additive were fixed. Solely the ABS base varied.
% heat resistance additive: 21%
% impact modifier additive 1: 5%
% impact modifier additive 2: 10%
Ratio: Impact modifier additive 2/Impact modifier additive 1=2

TABLE 11

| | Properties of recycled ABS | | | | | |
|---|---|---|---|---|---|---|
| | (without additive) | | | Properties of compositions | | |
| | | Flexural | | | Flexural | |
| | IZOD | modulus | HDT | IZOD | modulus | HDT |
| Ref | (kJ/m²) | (MPa) | (° C.) | (kJ/m²) | (MPa) | (° C.) |
| EGR0064 | 7.6 ± 0.2 | 2520 ± 30 | 92.5 ± 0.8 | 10.8 ± 0.4 | 2350 ± 18 | 99.3 ± 0.2 |
| EGR0074 | 12 ± 0.5 | 2480 ± 34.5 | 93.5 ± 0.3 | 11.6 ± 0.2 | 2320 ± 20 | 100 ± 0.1 |
| PLS0153 | 10.9 ± 0.2 | 2510 ± 32 | 94 ± 0.2 | 10.6 ± 0.4 | 2350 ± 22 | 100.5 ± 0.8 |
| BB36 | | | | | | |
| PLS0163 | 10.4 ± 0.3 | 2540 ± 29 | 92.5 ± 0.1 | 10.4 ± 0.4 | 2350 ± 32 | 98.6 ± 0.1 |
| BB1 | | | | | | |
| PLS0160 | 11.4 ± 0.3 | 2570 ± 35 | 92.1 ± 0.3 | 11.7 ± 0.2 | 2320 ± 11 | 98.9 ± 0.7 |
| BB21 | | | | | | |
| EV4 003 BB1 | 9.8 ± 0.3 | 2540 ± 15 | 92.5 ± 0.3 | 11 ± 0.2 | 2280 ± 45 | 98.5 ± 0.2 |

Depending on the source of recycled ABS, the impact strength and heat resistance properties vary significantly. However, the combined addition of a high heat resistant additive and impact modifier additive, as defined herein, allows the thermomechanical properties of these recycled ABS materials to be improved, irrespective of source.

1. A composition comprising:
an acrylonitrile-butadiene-styrene polymer or acrylonitrile-butadiene-styrene polymer derivative,
a high heat resistant additive selected from among a terpolymer of an N-substituted maleimide monomer, a vinyl monomer and an unsaturated dicarboxylic acid anhydride monomer, and a polyalphamethylstyrene, and mixtures thereof,
at least one impact modifier additive, and
at least one antioxidant additive.

2. The composition according to claim 1, wherein the weight content of high heat resistant additive varies from 15% to 35% by weight relative to the total weight of the composition.

3. The composition according to claim 1, wherein the total weight content of impact modifier additive varies from 8% to 35% by weight relative to the total weight of the composition.

4. The composition according to claim 1, wherein the impact modifier additive is selected from the group consisting of:
copolymers of ethylene and/or butene and a polar monomer chosen from among (m)ethyl acrylate, (m)ethyl methacrylate and butyl (meth)acrylate;
modified acrylonitrile-butadiene-styrene copolymers having a butadiene content higher than or equal to 60% by weight relative to the total weight of the modified acrylonitrile-butadiene-styrene polymer,
styrene-ethylene/butene-styrene copolymers grafted with maleic anhydride or glycidyl methacrylate;
ethylene-butyl acrylate copolymers, optionally grafted with maleic anhydride;
styrene-butadiene copolymers, block styrene-butadiene copolymers, or multiblock or diblock styrene-butadiene copolymers;
styrene-ethylene/butene-styrene copolymers, or block styrene-ethylene/butene-styrene copolymers; and
any of the mixtures thereof.

5. The composition according to claim 1, wherein the impact modifier additive comprises at least a first impact modifier additive and a second impact modifier additive.

6. The composition according to claim 5, wherein the ratio between the total weight content of first and second impact modifier additives and the weight content of high heat resistant additive varies from 0.3 to 2.0.

7. The composition according to claim 5, wherein the ratio between the weight content of second impact modifier additive and the weight content of first impact modifier varies from 0.1 to 12.

8. The composition according to claim 5, wherein the weight content of first impact modifier additive varies from 2% to 18%, by weight relative to the total weight of the composition.

9. The composition according to claim 5, wherein the weight content of second impact modifier additive varies from 5% to 25%, by weight relative to the total weight of the composition.

10. The composition according to claim 5, wherein the first impact modifier additive and second impact modifier additive differ from each other and are independently selected from the group consisting of:
copolymers of ethylene and/or butene and a polar monomer chosen from among (m)ethyl acrylate, (m)ethyl methacrylate and butyl (meth)acrylate;
modified acrylonitrile-butadiene-styrene copolymers having a butadiene content higher than or equal to 60% by weight relative to the total weight of the modified acrylonitrile-butadiene-styrene polymer;
styrene-butadiene copolymers, and
any of the mixtures thereof.

11. The composition according to claim 1, wherein the acrylonitrile-butadiene-styrene polymer or the acrylonitrile-butadiene-styrene polymer derivative is recycled.

12. A method for preparing the composition according to claim 1, comprising:
a step of mixing an acrylonitrile-butadiene-styrene polymer or an acrylonitrile-butadiene-styrene polymer derivative; a high heat resistant additive selected from among a terpolymer of an N-substituted maleimide monomer, a vinyl monomer, and an unsaturated dicarboxylic acid anhydride monomer, and a polyalphamethylstyrene, and mixtures thereof, at least one impact modifier additive and at least one antioxidant additive.

13. (canceled)

14. A part, a vehicle part, or an automotive vehicle part, comprising a composition according to claim 1.

15. A method to improve at least one thermal or mechanical property of a recycled acrylonitrile-butadiene-styrene polymer, or of a recycled acrylonitrile-butadiene-styrene polymer derivative, comprising the addition to the recycled acrylonitrile-butadiene-styrene polymer or to the recycled acrylonitrile-butadiene-styrene polymer derivative, of a composition comprising:
a high heat resistant additive selected from among a terpolymer of an N-substituted maleimide monomer, a vinyl monomer and an unsaturated dicarboxylic acid anhydride monomer; a polyalphamethylstyrene; and mixtures thereof,
at least one impact modifier additive, and
at least one antioxidant additive.

16. (canceled)
